(19) United States
(12) Patent Application Publication
(10) Pub. No.: US 2014/0269475 A1
(43) Pub. Date: Sep. 18, 2014

(54) APPARATUS AND METHOD FOR OPTIMIZING UPLINK SEMI-PERSISTENT SCHEDULING ACTIVATION

(71) Applicant: QUALCOMM Incorporated, San Diego, CA (US)

(72) Inventors: Navid EHSAN, San Diego, CA (US); Thomas KLINGENBRUNN, San Diego, CA (US); Aziz GHOLMIEH, San Diego, CA (US)

(73) Assignee: QUALCOMM Incorporated, San Diego, CA (US)

(21) Appl. No.: 14/137,767

(22) Filed: Dec. 20, 2013

Related U.S. Application Data
(60) Provisional application No. 61/785,751, filed on Mar. 14, 2013.

(51) Int. Cl. H04W 52/02; H04W 76/04; H04W 72/04

(52) U.S. Cl. CPC H04W 52/0235; H04W 72/04; H04W 76/048
USPC 370/311

(57) ABSTRACT

A method, an apparatus, and a computer program product for wireless communication are provided. The apparatus communicates with a UE in a DRX mode and using SPS and transmits information that enables the UE to reduce an amount of awake time while in the DRX mode and while using SPS. In another aspect, an apparatus communicates with a node using a DRX mode and using SPS and receives information that enables a reduction in an amount of awake time required while in the DRX mode and while using SPS.

### CROSS-REFERENCE TO RELATED APPLICATION(S)

This application claims the benefit of U.S. Provisional Application Ser. No. 61/785,751, entitled “Apparatus and Method for Optimizing Uplink SPS Activation” and filed on Mar. 14, 2013, which is expressly incorporated by reference herein in its entirety.

### BACKGROUND

1. Field

The present disclosure relates generally to communication systems, and more particularly, to an apparatus and method that optimizes uplink Semi-Persistent Scheduling (SPS) and its impact on Voice Over Internet Protocol (VoIP) over Long Term Evolution (LTE) (VoLTE).

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

UE battery life is a critical component of overall user satisfaction. It is therefore important that LTE procedures improve power savings to achieve this goal efficiently and without forcing the UE to unnecessarily waste battery power. One such LTE procedure is Discontinuous Reception (DRX). VoLTE power optimization relies on the LTE DRX functionality and increasing an “off” duration. The off duration includes, e.g., the time when the UE is not required to monitor Physical Downlink Control Channel (PDCCH). Increasing the off duration directly translates to lower VoLTE power use. This becomes challenging during talk spurts, due to the large amount overhead required for requests, receiving grants, and transmissions.

### SUMMARY

Aspects presented herein address the uplink scheduling challenges associated with Semi-Persistent Scheduling (SPS) and Discontinuous Reception (DRX) and provide ways to increase the amount of off time with SPS grants during VoLTE talk time.

In an aspect of the disclosure, a method, a computer program product, and an apparatus are provided. The apparatus communicates with a UE in a DRX mode and using SPS and transmits information that enables the UE to reduce an amount of awake time while in the DRX mode and while using SPS.

In another aspect, of the disclosure, a method, a computer program product, and an apparatus are provided. The apparatus communicates with a node using a DRX mode and using SPS and receives information that enables a reduction in an amount of awake time required while in the DRX mode and while using SPS.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIGS. 7a and 7b are diagrams illustrating aspects of a timeline for DRX and SPS scheduling.

FIGS. 8a and 8b are diagrams illustrating aspects of SPS operation with connected DRX mode.

FIGS. 9a and 9b are diagrams illustrating implementations of SPS operation with connected DRX mode.

FIG. 10 is a flow chart of a method of wireless communication of an eNB.

FIG. 11 is a conceptual data flow diagram illustrating the data flow between different modules/means/components in an exemplary eNB.

FIG. 12 is a diagram illustrating an example of a hardware implementation for an eNB employing a processing system.

FIG. 13 is a flow chart of a method of wireless communication of a UE.

FIG. 14 is a conceptual data flow diagram illustrating the data flow between different modules/means/components in an exemplary UE.

FIG. 15 is a diagram illustrating an example of a hardware implementation for a UE employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108.

The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

LTE includes two options for scheduling. In dynamic scheduling, such as DRX, when there is a lot of activity, the UE is required to be awake at multiple points in order to successfully use the scheduling. DRX includes periodically switching off a receiver, e.g., to save energy. DRX cycles may be configured in the LTE downlink so that the UE does not have to decode the PDCCH or receive Physical Downlink Shared Channel (PDSCH) transmissions in certain subframes. Additional details regarding DRX configurations and uplink grant scheduling can be found in 3GPP TS 36.321 Medium Access Control (MAC) protocol specification (Release 11), the entire contents of which are expressly incorporated by reference herein.

FIG. 7a illustrates aspects of a typical timeline 700 for dynamic scheduling, such as DRX. First, a new packet arrives. Thereafter, a scheduling request (SR) opportunity occurs. A scheduling request may be employed by the UE to request an allocation of uplink resources. This may occur, for example, when the UE has data ready for transmission but does not have a resource grant for the use of the Physical Uplink Shared Channel (PUSCH). The scheduling request may be transmitted on the Physical Uplink Control Channel (PUCCH). Thereafter, the UE receives an uplink grant on the Physical Downlink Control Channel (PDCCH). The UE may then transmit data on the PUSCH based on the resource grant it received. An acknowledgement (ACK) or negative acknowledgement (NACK) may be received in response to the transmission, indicating whether one or more blocks of data transmitted by the UE have been successfully received and/or decoded at the receiving end.

FIG. 7b illustrates aspects of a typical timeline 702 for semi-persistent scheduling (SPS). Semi-persistent scheduling enables radio resources to be semi-statically configured and allocated to a UE for a period of time longer than one subframe. SPS avoids the need for specific downlink assignment messages or uplink grant messages over the PDCCH for each subframe, such as those required during dynamic scheduled, as shown in FIG. 7a. Semi-persistent scheduling may be useful for services where the timing and amount of radio resources needed are predictable, thus reducing considerably the overhead of the PDCCH. Additional details regarding semi-persistent scheduling can be found in 3GPP TS 36.321 Medium Access Control (MAC) protocol specification (Release 11).

In FIG. 7b, after a new packet arrival, the UE may transmit on PUSCH, at the time indicated as SPS grant. A corresponding ACK/NACK may be received regarding the transmission. The scheduling request and grant signaling on PDCCH present during dynamic scheduling of FIG. 7a is not present during SPS.

As can be seen by FIG. 7a and FIG. 7b, the increased amount of activity involved in dynamic scheduling, as illustrated in FIG. 7a, requires a UE to be awake during additional times. FIG. 7b illustrates that the use of SPS reduces some of the overhead requirements, thereby reducing the amount of time during which the UE is required to be awake. For example, with SPS, the delay between a UE sending an scheduling request and receiving the grant is avoided. This savings may be variable, e.g., between 2-4 ms. There may also be a savings delay in the time period between the PDCCH and the PUSCH, e.g., approximately 4 ms. This may be removed through the use of a scheduling request-mask and periodically giving grants using dynamic scheduling. This amount of savings may be significant, especially considering that the DRX cycle that can be used with VoLTE is approximately between 20-40 ms.

VoLTE power optimization may rely on LTE DRX functionality in order to increase off durations. Increasing such off durations may directly translate to lower VoLTE power requirements so that battery life can be increased. This becomes challenging during talk spurts, due to the large overhead of requests, receiving grants, and transmissions.

FIG. 8a illustrates an ideal timeline 800 of SPS operation with connected mode DRX, wherein SPS and DRX are aligned. SPS and DRX typically have the same period or cycle duration, which may be between approximately 20-40 ms. The DRX cycle includes a DRX on-duration corresponding to the portion of the DRX cycle during which the UE may be required to monitor the downlink control channel. The DRX on-duration in FIG. 8a is four slots or subframes, and is 4 ms long. During the remaining portion of the DRX cycle, the UE neither receives nor transmits data. The DRX cycle corresponds to the period of time between the beginning of a DRX on-duration and the slot before the beginning of the next DRX on-duration. The SRS period corresponds to the time period between an SPS transmission on PUSCH and the slot before the next SPS transmission on PUSCH.

In order for SPS and DRX to coincide, an uplink SPS transmission on PUSCH would have to occur on the first sub-frame of a DRX on-duration. In order to obtain the ideal timeline illustrated in FIG. 8a, an activation of uplink SPS, also referred to a SPS activation, needs to occur within the active period. The active period is the time when the UE may be required to monitor the downlink control channel. This enables the uplink SPS transmission on PUSCH to occur, and possibly even an ACK/NACK received for the transmission within or just after the DRX on-duration. In practice, however, there is a 4 ms delay between a SPS activation and the time at which an uplink SPS transmission over PUSCH occurs. The delay between SPS activation and SPS uplink transmission on PUSCH is referred to as the SPS activation period. Therefore, if an uplink SPS transmission on PUSCH is to be sent at subframe n, the SPS activation command would need to be sent at subframe n-4.

FIG. 8b illustrates an example of a timeline 802 including a SPS activation period bound by an SPS activate command at one end and an uplink SPS transmission on PUSCH at the other end. In this timeline, an uplink SPS transmission on PUSCH may extend beyond the 4 ms DRX on-duration due to the time delay between SPS activation and uplink SPS transmission on PUSCH, thereby extending the active time for the UE. For example, in FIG. 8b, SPS activation occurs at the beginning of the DRX on-duration. However, 4 ms of awake time after the SPS activation are needed prior to the UE transmitting an uplink SPS transmission on PUSCH. Thus, the uplink SPS transmission on PUSCH is illustrated as being transmitted after the end of the 4 ms DRX on-duration. Accordingly, an issue arises wherein additional “on-time” results due to the offset between PUSCH transmissions and the on-duration.

In order to resolve this issue, any of a number of options may be applied.

FIG. 9a illustrates an example timeline resulting from a first implementation, wherein an eNB may maintain a UE in an awake state or on state. In this implementation, the eNB sends an SPS activation signal 904 4 ms before the first subframe 906 of a first DRX on-duration. This enables the UE to make an uplink SPS transmission on PUSCH 908 during the first subframe 906 of the DRX on-duration. This implementation requires the eNB to keep the UE in an awake mode during the DRX cycle preceding the SPS activation. The eNB may achieve this by sending smaller grants to the UE in order to re-start the UE's inactivity timer. In this case the only purpose of the grants would be to keep the UE awake. So the eNB would only allocate the smallest number of RBs (1) in order to keep the UE awake. For example, each time that the UE receives a grant, it resets an inactivity timer. This option may produce additional complexity in an eNB scheduler. Additionally, this option requires the UE to be listening to PDCCH in order to receive the SPS activation signal from the eNB. Thus, this option also requires some additional power usage by the UE.

FIG. 9b illustrates an example timeline resulting from a second implementation, wherein signaling may be used to specify timing of uplink SPS transmissions. In one configuration, MAC control signaling may be used to specify to a UE where an additional uplink SPS transmission on PUSCH should occur. For example, an additional MAC control element may be introduced that signals a specific offset to the UE. As one example, an eNB may send a MAC control element that specifies an offset x relative to a preceding subframe 910, that identifies a subsequent subframe 912 where an additional SPS transmission on PUSCH 914 may occur. In this implementation, upon SPS activation 916, the first PUSCH transmission 918 occurs 4 ms after receipt of the PDCCH activating the uplink SPS. In addition, the subsequent uplink SPS transmission on PUSCH 914 may occur at the subsequent subframe 912 that is x subframes after the preceding subframe 910.

The timing of the SPS grant for the additional uplink SPS transmission on PUSCH may be controlled by an explicit indication of an offset of activation time relative to a DRX on-duration. Thus, as shown in FIG. 9b, the offset x may be indicated to the UE with respect to the first subframe 910 of the DRX on-duration. Alternately, the timing of the SPS grant for a subsequent uplink SPS transmission on PUSCH may be controlled through the use of an indicator to signal alignment with the DRX on-duration. For example, one bit may be used to signal that the additional uplink SPS transmission on PUSCH should occur at the first subframe or slot of the DRX on-duration as indicated by DRX parameters. SPS activation is still needed to be signaled through PDCCH. The indication to align with the on-duration can be done through a separate signaling (e.g. MAC control element). As an additional alternative, an explicit indication may be made of the start of a system frame number (SFN)/subframe number for the activation time. The goal is to make sure the uplink transmissions are aligned with on-duration. In order to achieve this, there are two ways: 1) to just use one bit 0/1 to indicate whether UL transmissions should be aligned with on-duration; or 2) provide a specific subframe offset on when the next transmission should take place. In either method, the signaling can be done through L1 or L2 layer.

In another configuration using signaling, the timing of uplink SPS transmission may be adjusted through the use of RRC signaling. In this option, a new field may be added to the uplink SPS configuration parameters to specify an offset y relative to a preceding subframe 910 that identifies a subsequent subframe 920 for an uplink SPS transmission on PUSCH 922. Upon activation of SPS 910 using lower layer signaling, the first uplink SPS transmission on PUSCH 918 may occur approximately 4 ms after activation. A subsequent uplink SPS transmission on PUSCH 920 may occur using the offset y specified in the RRC signaling. This enables the start of the second DRX on-duration to be aligned with the subsequent uplink SPS transmission.

FIG. 10 is a flow chart 1000 of a method of wireless communication. The method may be performed by an eNB. Optional aspects are illustrated using a dashed line. At step 1002, the eNB communicates with a UE in a DRX mode and using SPS. In an aspect, the communication may be performed by communication components, including any of a reception module and a transmission module, e.g., 1104 and 1106 in FIG. 11. The UE may be the UE 1150 in FIG. 11.

At step 1004, the eNB transmits information that enables the UE to reduce an amount of awake time while in the DRX mode and while using SPS. In an aspect, the transmission may be performed by a transmission module, e.g., 1106 in FIG. 11.

At step 1006, the eNB may transmit an SPS activation signal prior to the beginning of a DRX on-duration. The SPS activation signal may be transmitted, e.g., approximately 4 ms prior to the beginning of the DRX on-duration. By sending smaller grants to the UE, the eNB may cause the UE to restart an inactivity timer. This enables the UE to be awake when the DRC on-duration begins, so that it can send the SPS transmission within the DRX on-duration. In an aspect, the SPS transmission may be performed by an SPS module 1108 in FIG. 11.

At step 1008, the eNB may signal an offset using a MAC element prior to activating uplink SPS. This may be done, e.g., through the introduction of a new MAC control element. The eNB may send the MAC control element at any time before activating SPS. The signaling may indicate an offset of an activation time relative to the beginning of a DRX on-duration. In another aspect, the signaling may indicate whether a transmission should occur at the first slot of a DRX on-duration. The signaling may comprise a single bit. In another aspect, the signaling may comprise an indication of at least one of a starting frame number and a starting subframe number of an activation time. In an aspect, the signaling may be performed by a MAC element module 1110 in FIG. 11.

At step 1010, the eNB may signal an offset for uplink SPS transmissions via RRC signaling. This may include adding a new field to the UL SPS configuration parameters to specify an offset for UL SPS transmissions. Upon activation of UL SPS using lower layer signaling, the first transmission from the UE may occur 4 ms after activation and subsequent uplink SPS transmissions may occur using the offset specified in the RRC signaling. This may allow the DRX on-duration to be aligned with SPS grants. In an aspect, the signaling may be performed by an RRC module 1112 in FIG. 11.

FIG. 11 is a conceptual data flow diagram 1100 illustrating the data flow between different modules/means/components in an exemplary apparatus 1102. The apparatus may be an eNB. The apparatus includes a receiving module 1104 that receives communication from a UE 1150, and a transmission module 1106 that transmits communication the UE. Any of the receiving module 1104 and the transmission module 1106 may be involved in communication with a UE in a DRX mode and using SPS. The apparatus 1102 may include an SPS module 1108 that transmits an SPS activation signal prior to the beginning of a DRX on-duration, a MAC element module 1110 that signals an offset using a MAC element prior to activating uplink SPS, and an RRC module 1112 that signals an offset for uplink SPS transmissions via RRC signaling.

The apparatus 1102 may include additional modules that perform each of the steps of the algorithm in the aforementioned flow chart of FIG. 10. As such, each step in the aforementioned flow chart of FIG. 10 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

FIG. 12 is a diagram 1200 illustrating an example of a hardware implementation for an apparatus 1102′ employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1204, the modules 1104, 1106, 1108, 1110, and 1112, and the computer-readable medium 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The processing system 1214 includes a processor 1204 coupled to a computer-readable medium 1206. The processor 1204 is responsible for general processing, including the execution of software stored on the computer-readable medium 1206. The software, when executed by the processor 1204, causes the processing system 1214 to perform the various functions described supra for any particular apparatus. The computer-readable medium 1206 may also be used for storing data that is manipulated by the processor 1204 when executing software. The processing system further includes at least one of the modules 1104, 1106, 1108, 1110, and 1112. The modules may be software modules running in the processor 1204, resident/stored in the computer readable medium 1206, one or more hardware modules coupled to the processor 1204, or some combination thereof. The processing system 1214 may be a component of the eNB 610 and may include the memory 676 and/or at least one of the TX processor 616, the RX processor 670, and the controller/processor 675.

In one configuration, the apparatus 1102/1102′ for wireless communication includes any of means for communicating with a UE in DRX mode and using SPS, means for transmitting information that enables the UE to reduce an amount of awake time while in the DRX mode and while using SPS, means for transmitting an SPS activation signal prior to the beginning of a DRX on-duration, means for signaling an offset using a MAC element prior to activating uplink SPS, and means for signaling an offset for uplink SPS transmissions via RRC signaling.

The aforementioned means may be one or more of the aforementioned modules of the apparatus 1102 and/or the processing system 1214 of the apparatus 1102′ configured to perform the functions recited by the aforementioned means. As described supra, the processing system 1214 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

FIG. 13 is a flow chart 1300 of a method of wireless communication. The method may be performed by a UE. Optional aspects are illustrated using a dashed line. At step 1302, the UE communicates with a node using a DRX mode and using SPS. In an aspect, the communication may be performed by communication components, including any of a reception module 1404 and a transmission module 1406 in FIG. 14. The node may be an eNB 1450 in FIG. 14.

At step 1304, the UE receives information from an eNB that enables a reduction in an amount of awake time required while in the DRX mode and while using SPS. In an aspect, the reception may be performed by a receiving module 1404 in FIG. 14.

At step 1306, the UE may receive an SPS activation signal prior to the beginning of a DRX on-duration. In an aspect, the reception may be performed by any of a receiving module 1402 and an SPS module 1408 in FIG. 14. The SPS activation signal may be received, e.g., approximately 4 ms prior to the beginning of the DRX on-duration. Thereafter, at 1308, the UE may transmit UL communication during the DRX on-duration. In an aspect, the transmission may be performed by a transmission module 1406 in FIG. 12.

At step 1310, the UE may receive signaling of an offset via a MAC element prior to uplink SPS activation. In an aspect, the signaling may comprise an indication of an offset of an activation time relative to the beginning of the DRX on-duration. In another aspect, the signaling may comprise an indication that indicates whether a transmission should occur at the first slot of the on-duration. The indication may be received, e.g., as a single bit. In another aspect, the signaling may comprise an indication of at least one of a starting frame number and a starting subframe number of an activation time. In an aspect, the reception may be performed by any of a receiving module 1404 and a MAC element module 1410 in FIG. 14. Thereafter, at step 1312, the UE may transmit communication at a subframe having the signaled offset. In an aspect, the transmission may be performed by a transmission module 1406 in FIG. 14.

At step 1314, the UE may receive signaling of an offset for uplink SPS transmissions via RRC signaling. In an aspect, the reception may be performed by any of a receiving module 1404 and an RRC module 1412 in FIG. 14. Thereafter, at 1316, the UE may transmit communication approximately 4 ms after activation, and at 1318, the UE may transmit subsequent transmissions using the offset. In an aspect, the transmission may be performed by a transmission module 1406 in FIG. 14.

FIG. 14 is a conceptual data flow diagram 1400 illustrating the data flow between different modules/means/components in an exemplary apparatus 1402. The apparatus may be a UE. The apparatus includes components that communicate with a node. The node may comprise an eNB 1450. Such communication components may include a receiving module 1404 that receives transmissions from the node and a transmission module 1406 that transmits communication to the node. The apparatus 1402 may communicate with the node using DRX mode and using SPS. The receiving module 1404 may receive information that enables a reduction in an amount of awake time required while in the DRX mode and while using SPS.

The apparatus 1402 may include a SPS module 1408 that receives an SPS activation signal prior to the beginning of a DRX on-duration. The transmission module 1406 may be configured to transmit UL communication during the DRX on-duration after receiving the SPS activation.

The apparatus 1402 may include a MAC element module 1410 that receives signaling of an offset via a MAC element prior to uplink SPS activation. The transmission module 1406 may then transmit communication at a subframe having the signaled offset.

The apparatus 1402 may include an RRC module 1412 that receives signaling of an offset for uplink SPS transmissions via RRC signaling. Thereafter the transmission module 1406 may transmit communication approximately 4 ms after activation and transmit subsequent transmissions using the offset

The apparatus 1402 may include additional modules that perform each of the steps of the algorithm in the aforementioned flow chart of FIG. 13. As such, each step in the aforementioned flow charts of FIG. 13 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

FIG. 15 is a diagram 1500 illustrating an example of a hardware implementation for an apparatus 1402′ employing a processing system 1514. The processing system 1514 may be implemented with a bus architecture, represented generally by the bus 1524. The bus 1524 may include any number of interconnecting buses and bridges depending on the specific application of the processing system 1514 and the overall design constraints. The bus 1524 links together various circuits including one or more processors and/or hardware modules, represented by the processor 1504, the modules 1404, 1406, 1408, 1410, and 1412, and the computer-readable medium 1506. The bus 1524 may also link various other circuits such as timing sources, peripherals, voltage regulators, and power management circuits, which are well known in the art, and therefore, will not be described any further.

The processing system 1514 may be coupled to a transceiver 1510. The transceiver 1510 is coupled to one or more antennas 1520. The transceiver 1510 provides a means for communicating with various other apparatus over a transmission medium. The processing system 1514 includes a processor 1504 coupled to a computer-readable medium 1506. The processor 1504 is responsible for general processing, including the execution of software stored on the computer-readable medium 1506. The software, when executed by the processor 1504, causes the processing system 1514 to perform the various functions described supra for any particular apparatus. The computer-readable medium 1506 may also be used for storing data that is manipulated by the processor 1504 when executing software. The processing system further includes at least one of the modules 1404, 1406, 1408, 1410, and 1412. The modules may be software modules running in the processor 1504, resident/stored in the computer readable medium 1506, one or more hardware modules coupled to the processor 1504, or some combination thereof. The processing system 1514 may be a component of the UE 650 and may include the memory 660 and/or at least one of the TX processor 668, the RX processor 656, and the controller/processor 659.

In one configuration, the apparatus 1402/1402′ for wireless communication includes means for means for means for communicating with a node using a DRX mode and using SPS, means for receiving information that enables a reduction in an amount of awake time required while in the DRX mode and while using SPS, and means for transmitting communication, e.g., uplink communication. The aforementioned means may be one or more of the aforementioned modules of the apparatus 1402 and/or the processing system 1514 of the apparatus 1402′ configured to perform the functions recited by the aforementioned means. As described supra, the processing system 1514 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
communicating with a User Equipment (UE) in a Discontinuous Reception (DRX) mode and using Semi-Persistent Scheduling (SPS); and
transmitting information that enables the UE to reduce an amount of awake time while in the DRX mode and while using SPS.

2. The method of claim 1, further comprising transmitting an SPS activation signal prior to a beginning of a DRX on-duration.

3. The method of claim 2, wherein the SPS activation signal is transmitted approximately 4 ms prior to the beginning of the DRX on-duration.

4. The method of claim 1, further comprising signaling an offset using a Media Access Control (MAC) element prior to activating uplink SPS.

5. The method of claim 4, wherein the signaling indicates an offset of an activation time relative to a beginning of a DRX on-duration.

6. The method of claim 4, wherein the signaling indicates whether a transmission should occur at a first slot of a DRX on-duration.

7. The method of claim 6, wherein the signaling comprises a single bit.

8. The method of claim 4, wherein the signaling comprises an indication of at least one of a starting frame number and a starting subframe number of an activation time.

9. The method of claim 1, further comprising signaling an offset for uplink SPS transmissions via radio resource control (RRC) signaling.

10. An apparatus for wireless communication, comprising:
means for communicating with a User Equipment (UE) in a Discontinuous Reception (DRX) mode and using Semi-Persistent Scheduling (SPS); and
means for transmitting information that enables the UE to reduce an amount of awake time while in the DRX mode and while using SPS.

11. The apparatus of claim 10, further comprising means for transmitting an SPS activation signal prior to a beginning of a DRX on-duration.

12. The apparatus of claim 11, wherein the SPS activation signal is transmitted approximately 4 ms prior to the beginning of the DRX on-duration.

13. The apparatus of claim 10, further comprising means for signaling an offset using a Media Access Control (MAC) element prior to activating uplink SPS.

14. The apparatus of claim 13, wherein the signaling indicates an offset of an activation time relative to a beginning of a DRX on-duration.

15. The apparatus of claim 13, wherein the signaling indicates whether a transmission should occur at a first slot of a DRX on-duration.

16. The apparatus of claim 15, wherein the signaling comprises a single bit.

17. The apparatus of claim 13, wherein the signaling comprises an indication of at least one of a starting frame number and a starting subframe number of an activation time.

18. The apparatus of claim 10, further comprising means for signaling an offset for uplink SPS transmissions via radio resource control (RRC) signaling.

19. An apparatus for wireless communication, comprising:
a processing system configured to:
communicate with a User Equipment (UE) in a Discontinuous Reception (DRX) mode and using Semi-Persistent Scheduling (SPS); and
transmit information that enables the UE to reduce an amount of awake time while in the DRX mode and while using SPS.

20. The apparatus of claim 19, wherein the processing system is further configured to transmit an SPS activation signal prior to a beginning of a DRX on-duration.

21. The apparatus of claim 20, wherein the SPS activation signal is transmitted approximately 4 ms prior to the beginning of the DRX on-duration.

22. The apparatus of claim 19, wherein the processing system is further configured to signal an offset using a Media Access Control (MAC) element prior to activating uplink SPS.

23. The apparatus of claim 22, wherein the signaling indicates an offset of an activation time relative to a beginning of a DRX on-duration.

24. The apparatus of claim 22, wherein the signaling indicates whether a transmission should occur at a first slot of a DRX on-duration.

25. The apparatus of claim 24, wherein the signaling comprises a single bit.

26. The apparatus of claim 22, wherein the signaling comprises an indication of at least one of a starting frame number and a starting subframe number of an activation time.

27. The apparatus of claim 19, wherein the processing system is further configured to signal an offset for uplink SPS transmissions via radio resource control (RRC) signaling.

28. A computer program product, comprising:
a computer-readable medium comprising code for:
communicating with a User Equipment (UE) in a Discontinuous Reception (DRX) mode and using Semi-Persistent Scheduling (SPS); and
transmitting information that enables the UE to reduce an amount of awake time while in the DRX mode and while using SPS.

29. A method of wireless communication, comprising:
communicating with a node using a Discontinuous Reception (DRX) mode and using Semi-Persistent Scheduling (SPS); and
receiving information that enables a reduction in an amount of awake time required while in the DRX mode and while using SPS.

30. The method of claim 29, further comprising:
receiving an SPS activation signal prior to a beginning of a DRX on-duration; and
transmitting uplink communication during the DRX on-duration.

31. The method of claim 30, wherein the SPS activation signal is received approximately 4 ms prior to the beginning of the DRX on-duration.

32. The method of claim 29, further comprising:
receiving signaling of an offset via a Media Access Control (MAC) element prior to uplink SPS activation; and
transmitting communication at a subframe having the signaled offset.

33. The method of claim 32, wherein the signaling comprises an indication of an offset of an activation time relative to a beginning of the DRX on-duration.

34. The method of claim 32, wherein the signaling comprises an indication of whether a transmission should occur at a first slot of the on-duration.

35. The method of claim 34, wherein the indication is received as a single bit.

36. The method of claim 32, wherein the signaling comprises an indication of at least one of a starting frame number and a starting subframe number of an activation time.

37. The method of claim 29, further comprising:
receiving signaling of an offset for uplink SPS transmissions via radio resource control (RRC) signaling;
transmitting communication approximately 4 ms after activation; and
transmitting subsequent transmissions using the offset.

38. An apparatus for wireless communication, comprising:
means for communicating with a node using a Discontinuous Reception (DRX) mode and using Semi-Persistent Scheduling (SPS); and
means for receiving information that enables a reduction in an amount of awake time required while in the DRX mode and while using SPS.

39. The apparatus of claim 38, further comprising:
means for receiving an SPS activation signal prior to a beginning of a DRX on-duration, wherein the means for communication transmit uplink communication during the DRX on-duration.

40. The apparatus of claim 39, wherein the SPS activation signal is received approximately 4 ms prior to the beginning of the DRX on-duration.

41. The apparatus of claim 38, further comprising:
means for receiving signaling of an offset via a Media Access Control (MAC) element prior to uplink SPS activation, wherein the means for communication transmit communication at a subframe having the signaled offset.

42. The apparatus of claim 41, wherein the signaling comprises an indication of an offset of an activation time relative to a beginning of the DRX on-duration.

43. The apparatus of claim 41, wherein the signaling comprises an indication of whether a transmission should occur at a first slot of the on-duration.

44. The apparatus of claim 43, wherein the indication is received as a single bit.

45. The apparatus of claim 41, wherein the signaling comprises an indication of at least one of a starting frame number and a starting subframe number of an activation time.

46. The apparatus of claim 38, further comprising: means for receiving signaling of an offset for uplink SPS transmissions via radio resource control (RRC) signaling, wherein the means for communication transmit communication approximately 4 ms after activation and transmit subsequent transmissions using the offset.

47. An apparatus for wireless communication, comprising:
a processing system configured to:
communicate with a node using a Discontinuous Reception (DRX) mode and using Semi-Persistent Scheduling (SPS); and
receive information that enables a reduction in an amount of awake time required while in the DRX mode and while using SPS.

48. The apparatus of claim 47, wherein the processing system is further configured to:
receive an SPS activation signal prior to a beginning of a DRX on-duration; and
transmit uplink communication during the DRX on-duration.

49. The apparatus of claim 48, wherein the SPS activation signal is received approximately 4 ms prior to the beginning of the DRX on-duration.

50. The apparatus of claim 47, wherein the processing system is further configured to:
receive signaling of an offset via a Media Access Control (MAC) element prior to uplink SPS activation; and
transmit communication at a subframe having the signaled offset.

51. The apparatus of claim 50, wherein the signaling comprises an indication of an offset of an activation time relative to a beginning of the DRX on-duration.

52. The apparatus of claim 50, wherein the signaling comprises an indication of whether a transmission should occur at a first slot of the on-duration.

53. The apparatus of claim 52, wherein the indication is received as a single bit.

54. The apparatus of claim 50, wherein the signaling comprises an indication of at least one of a starting frame number and a starting subframe number of an activation time.

55. The apparatus of claim 47, wherein the processing system is further configured to:
receive signaling of an offset for uplink SPS transmissions via radio resource control (RRC) signaling;
transmit communication approximately 4 ms after activation; and
transmit subsequent transmissions using the offset.

56. A computer program product, comprising:
a computer-readable medium comprising code for:
communicating with a node using a Discontinuous Reception (DRX) mode and using Semi-Persistent Scheduling (SPS); and
receiving information that enables a reduction in an amount of awake time required while in the DRX mode and while using SPS.
